(19) United States
(12) Patent Application Publication
(10) Pub. No.: US 2004/0262586 A1
(43) Pub. Date: Dec. 30, 2004

(54) Staple remover

(76) Inventor: John Moscone, Rochester, NH (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/827,096

(22) Filed: Apr. 19, 2004

Related U.S. Application Data
(60) Provisional application No. 60/463,863, filed on Apr. 18, 2003.

(51) Int. Cl. B27F 7/00

(52) U.S. Cl. 254/28

(57) ABSTRACT

A hand tool that may be useful for removing staples includes two jaws pivotally engaged to one another and including respective handles extending from each jaw. Each jaw may include a bearing surface and a lifting surface converging with the bearing surface to provide a wedge. Each jaw may also include a medial surface and a lateral surface converging with the medial surface. The converging lifting surface and bearing surface in combination with the converging lateral surface and medial surface may provide a point on each jaw to facilitate engaging under a staple.

### CROSS-REFERENCE TO RELATED APPLICATIONS

This application claims the benefit of U.S. provisional patent application Serial No. 60/463,863, filed on Apr. 18, 2003, the entire disclosure of which application is incorporated herein by reference.

### FIELD

The present invention is directed at hand tools, and more particularly hand tools for facilitating the removal of staples.

### BACKGROUND

As it exits now electricians and furniture upholsterers, etc. require the use of 2 separate tools and 2-3 separate steps to remove staples. Typically an embedded staple must first be pried loose with a screw driver or similar small prying tool. The staple must then be extracted, for example, by grasping the staples with a pair of pliers and forcibly pulling the staple out. If the staple is deeply embedded, additional prying steps may be required. The staple may have to be pried out using a prying tool and, for example, a block of wood as fulcrum.

In addition the difficult job of removing staples from wood, which staples may be embedded as much as an inch, requires a great deal of force to extract the staples. In the case of workers that frequently have to remove such deeply embedded staples, this force can compound neck and shoulder injuries as well as soft tissue injuries of the hands and arms. There is, therefore, a need for a single tool that may easily and quickly remove staples that may be deeply embedded or otherwise difficult to remove.

### BRIEF DESCRIPTION OF DRAWINGS

Features and advantages of embodiments of the claimed subject matter will be apparent from the following Description, which should be considered in conjunction with the accompanying drawings, wherein:

FIG. 1 shows an embodiment of a staple remover consistent with the present disclosure in a perspective view;

FIG. 2 is an enlarged perspective view of a top portion of the staple remover shown in FIG. 1;

FIG. 3 is a schematic side elevation of a jaw member of a staple remover according to the present disclosure;

FIG. 4 is a top view of one jaw member illustrated in FIG. 3;

FIG. 5 is a top view of the staple remover of FIG. 3 shown with the jaw members in a closed configuration;

FIG. 6 is a top view of the staple remover of FIG. 3 shown with the jaws in an open configuration;

FIG. 7 is another embodiment of a staple remover according to the present disclosure;

FIG. 8 shows a side view of a jaw portion that may suitably be used with one embodiment of a staple remover according to the present disclosure; and

FIG. 9 is a cross-sectional view of the jaw portion shown in FIG. 8.

### DESCRIPTION

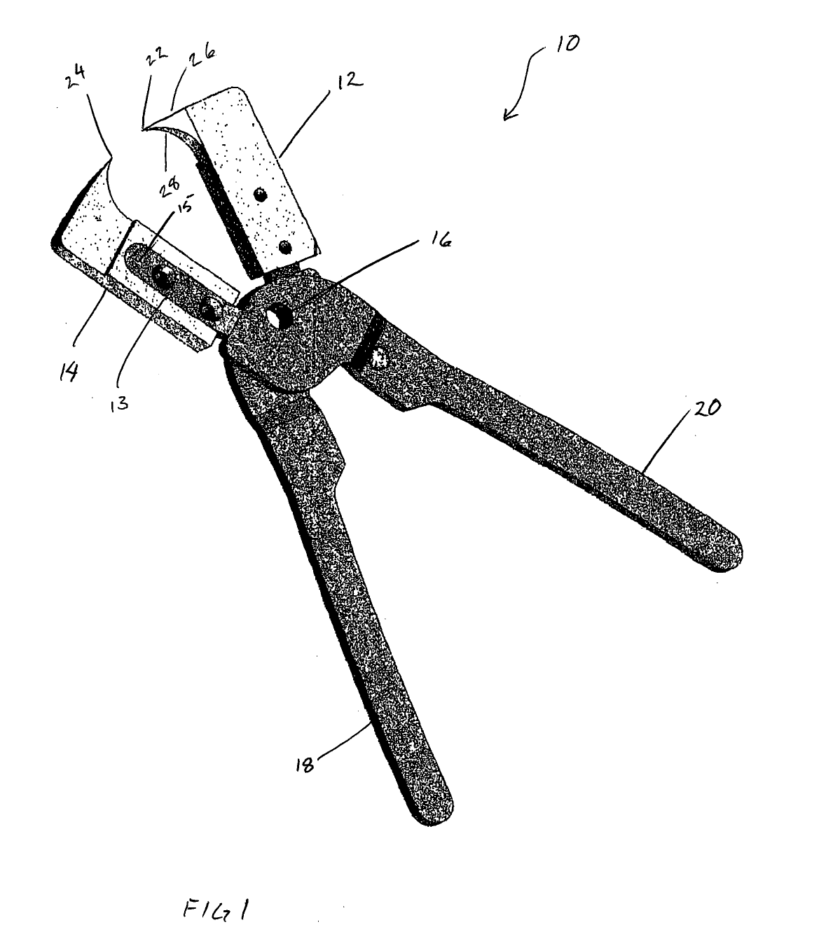

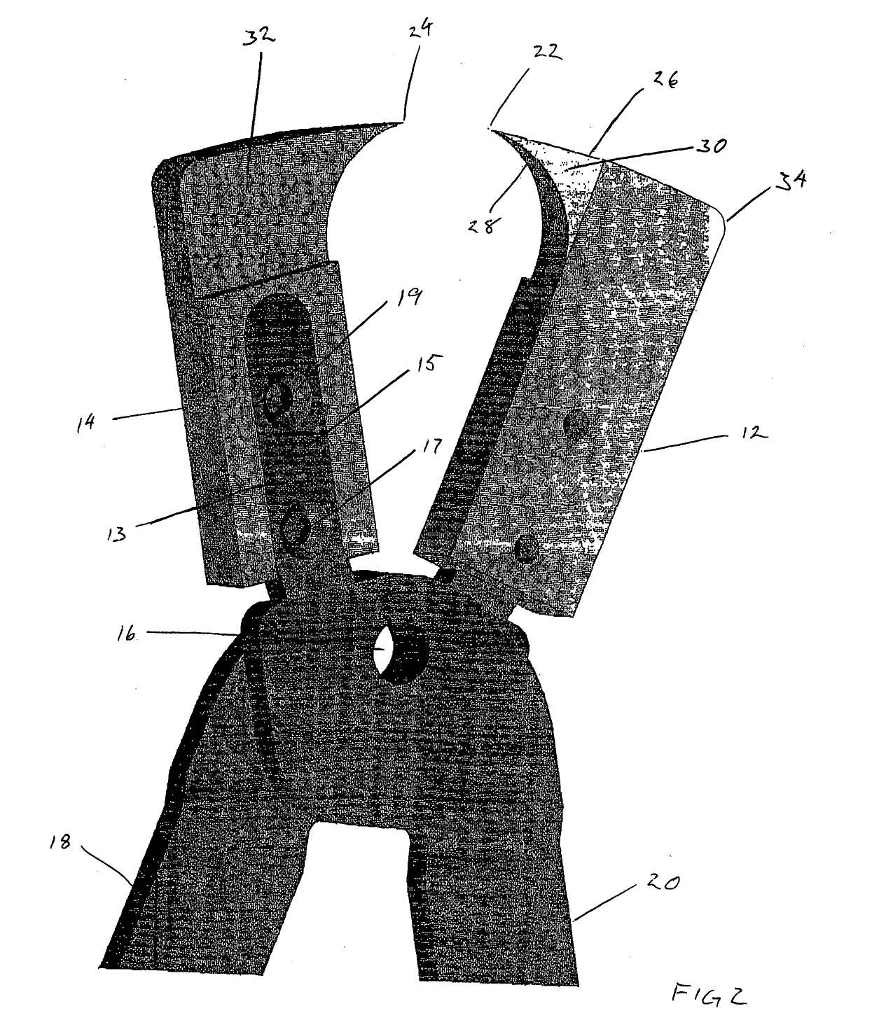

Referring to FIGS. 1 and 2, an embodiment of a staple remover 10 consistent with the present disclosure is shown. The illustrated staple remover 10 is generally configured as pliers, and may include first and second jaws 12, 14 that are pivotally engaged with one another about a pivot point 16. Each jaw 12, 14 may be coupled across the pivot point 16 to a respective handle 18 and 20. The jaws 12, 14 may be directly coupled to the handles 18, 20 as illustrated, or may be indirectly coupled to the handles 18, 20 through one or more intermediary components. Pivotal movement of the handles 18, 20 effects a corresponding movement of the jaws 12, 14. That is, urging the handles 18, 20 towards one another urges the jaws 12, 14 towards one another.

With further reference also to FIG. 2, each jaw 12, 14 of the staple remover 10 may taper to a point 22, 24 in two planes. The points 22, 24 of the jaws 12, 14 may be oriented facing each other, as shown in the illustrated embodiment. With reference to the first jaw 12 for the convenience of explanation, the jaw 12 may include a bearing surface 26 at the head, or end, of the jaw, and an opposed lifting surface 28. The lifting surface 28 may converge toward the bearing surface 26 to form the point 22 in a first plane. In the illustrated embodiment, the bearing surface 26 is depicted as a generally flat surface and the lifting surface 28 is shown to be a concave arcuate surface. According to other embodiments consistent with the present disclosure, the bearing surface may be either flat or arcuate. Similarly, consistent with the present disclosure, the lifting surface may also be flat or arcuate, either concave or convex.

The jaw 12 may also include a lateral, or outside, surface 30. As best observed with reference to the second jaw 14, the jaw 14 may also include a medial, or inside, surface 32. The first jaw, 12, may include a similar medial surface, not visible in views of FIGS. 1 and 2. The medial and lateral 30 surfaces of the jaw 12 may also converge to form the point 22 in a second plane. Consistent with the present disclosure, the converging lateral surface 30 may have either a flat or an arcuate profile. The jaws 12, 14 may be configured so that the points 22, 24 overlap one another when the jaws 12, 14 are in a closed configuration.

According to the described embodiment, the staple remover 10 may be used to extract staples from a surface. The jaws 12, 14 may be opened such that the points 22, 24 are sufficiently spaced to be positioned on either side of a staple. The jaws 12, 14 may then be urged together by squeezing the handles 18, 20 together. The jaws 12, 13 may be urged together with one point 22, 24 positioned on either side of the staple, which may allow the points 22, 24 to engage an underside of the staple. When the jaws 12, 14 are urged toward a closed configuration the lifting surface 28 of one or both jaws 12, 14 may wedge underneath the staple. As the lifting surface 28 wedges under the staple, the bearing surface 26 may act against the surface the staple is embedded in and/or against a member or article disposed between the staple and the surface, e.g. an electrical wire retained to a surface by a staple.

As the jaws 12, 14 of the staple remover 10 are closed, the points 22, 24 may advance toward one another and assume an overlapped arrangement. The overlapping arrangement of the points 22, 24 may keep the staple generally centered between the jaws 12, 14 and may provide an additional wedging action. The resulting wedging action of the lifting surface 28 against the staple as the jaws 12, 14 are closed may lift the staple from the surface. Additional lifting action may be applied by rocking the at least partially closed jaws 12, 14 of the staple remover 10 back and forth across the bearing surface 26. The staple remover 10 may also be levered away from a staple being extracted using a heel 34 of one of the jaws 12, 14 as a fulcrum. Levering the staple remover 10 away from the staple may provide even greater lifting of the staple from the surface.

Staples used to secure, for example, non-metallic sheathed electrical cable may include plastic insulation on at least a portion of the staple. When electrical cable is secured using such insulated staples the insulation of the staple may deform and closely conform around the electrical cable. The non-metallic sheathing of the electrical cable may also deform as a result of contact pressure between the staple and the electrical cable. The deformation of the electrical insulation of the staple and/or the deformation of the non-metallic sheathing of the electrical cable may result little or no spacing or gaps between the staple and the electrical cable. The lack of spacing or gaps between the staple and the electrical cable may make it difficult to get a purchase on the staple to allow extraction. Consistent with one aspect, the points 22, 24 of the staple remover 10 may drive through the insulation of the staple and allow the points 22, 24 of the jaws 12, 14 to get under the staple to allow removal thereof. That is, the points 22, 24 may deform, tear, and/or pierce the insulation of the staple to facilitate removal of the staple.

In an embodiment in which the points 22, 24 are formed by tapering surfaces in two planes, the portion of the jaws 12, 14 that may first engage a staple to be removed may be relatively narrow. This aspect may allow the staple remover 10 to grasp and remove staples when it is possible to achieve only a minimal initial purchase on the staple. Additionally, the relatively narrow initial engagement between the staple remover 10 and a staple may allow narrow staples as well as wide staples to be removed using the staple remover.

While the discussion of various features of the staple remover 10 has called out attributes with reference to one of the jaws or the other, according to one embodiment the jaws may be provided having generally the same configuration. In such an embodiment one jaw may have most, or all, of the same attributes as the other, only with the jaw as a whole positioned in a different orientation. However, while it may be the case that the two jaws may be the same, it is not necessary aspect of the present disclosure that the two jaws be the same.

Referring to FIGS. 3 through 6, another embodiment of a staple remover is illustrated. FIG. 3 shows a jaw 12a in a profile view. As illustrated, the jaw 12a may include an arcuate bearing surface 26a, and an arcuate lifting surface 28a. The bearing surface 26a and the lifting surface 28a converge to provide a point 22a in the profile elevation of the jaw 12a. The arcuate bearing surface 26a may extend across the head 40 of the jaw 12a. Additionally, the jaw 12a may include a radiused fulcrum heel 42.

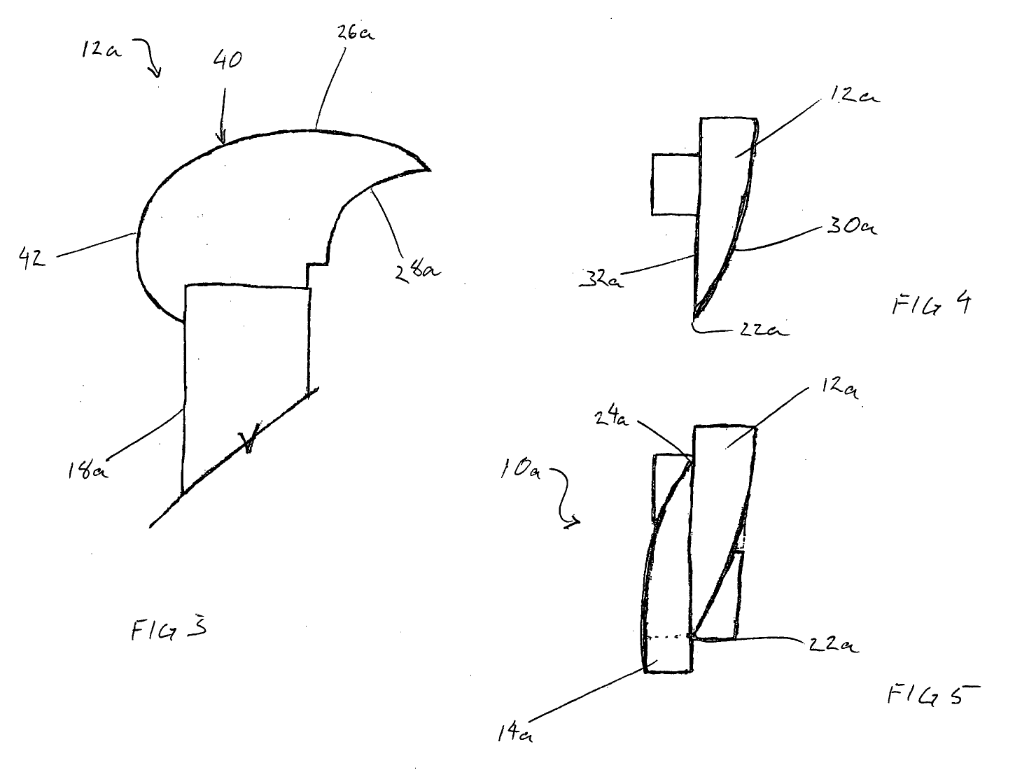

FIGS. 4 through 6 illustrate various top views of the staple remover. FIG. 4 illustrates a single jaw 12a as viewed from the top or head 40 of the jaw 12a. Consistent with the illustrated embodiment, the lateral surface 30a may be generally arcuate and may converge toward the medial surface 32a to provide the jaw 12a with a point 22a viewed from the top elevation. The converging bearing surface 26a and lifting surface 28a in combination with the converging lateral 30a and medial 32a surfaces may provide the point 22a having a configuration resembling a beak that may facilitate engaging under a staple.

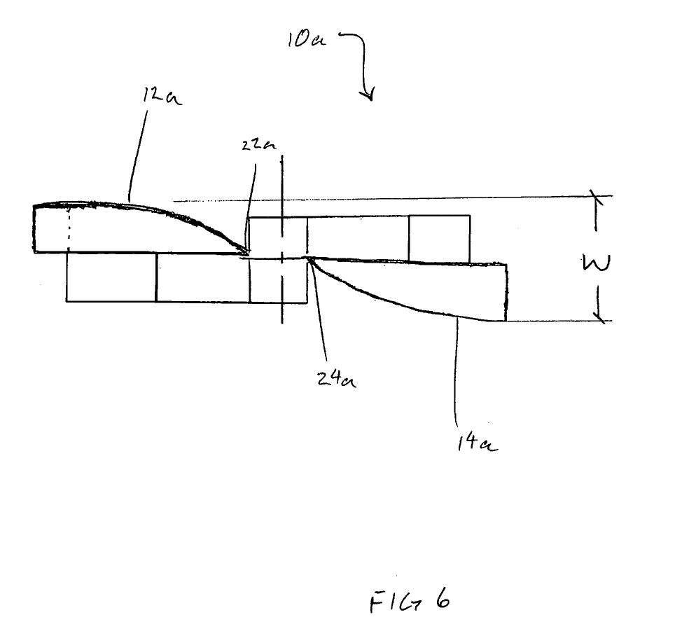

Turning to FIG. 5, an embodiment of a staple remover 10a is shown with the jaws 12a, 14a in a closed configuration from a top elevation. In a closed configuration, the points 22a, 24a or the jaws 12a, 14a may assume an overlapping arrangement. In the illustrated embodiment, the points 22a, 24a may be shielded by, or not extend beyond, the other respective jaw 12a, 14a when the staple remover 10a is in a closed configuration. The shielded arrangement of the points 22a, 24a may reduce the occurrence of injury to a user, and may prevent or reduce damage to a surface from which a staple is being removed or an object being retained by a staple.

Operation of the embodiment shown in FIGS. 3 through 6 is similar to operation of the first described embodiment. With the jaws 12a, 14a in an opened configuration, as shown in FIG. 6, the points 22a, 24a may be positioned on either side of a staple embedded in a surface. The jaws 12a, 14a may be urged together by squeezing the handles (not shown) together. When the jaws 12a, 14a are closed or urged together by grasping the handles, the points 22a, 24a of the jaws 12a, 14a may engage under the staple. The bearing surface 26a of one or both jaws 12a, 14a may act against the surface, and the lifting surface 28a of one or both jaws 12a, 14a may act against the underside of the staple. Urging the jaws 12a, 14a further toward a closed configuration, as shown in FIG. 5, may urge the wedge formed by the converging bearing surface 26a and lifting surface 28a under the staple. According to the disclosure, lifting of the staple may be facilitated both by the mechanical advantage of the wedge formed by the converging lifting surface 28a and bearing surface 26a, and by the mechanical advantage provided by the leverage produced by the handles of the staple remover 10a.

As the staple is lifted, the jaws 12a, 14a may advance toward one another and the points 22a, 24a may assume an overlapped, or closed, arrangement, such as illustrated in FIG. 5. Once the jaws 12a, 14a have advanced at least partially underneath the staple the staple remover 10a may be used in the manner of a pair of pliers and the staple may be fully removed by withdrawing the at least partially closed staple remover 10a away from the surface in which the staple is embedded. The at least partially overlapping points 22a, 24a may provide a secure purchase on the staple that may allow the staple to be pulled out without the staple remover 10a loosing grip on the staple. That is, the secure purchase on the staple provided by the at least partially overlapping points 22a, 24a may reduce the amount of closing force on the handles that is necessary to retain the staple while extracting the staple by withdrawing the staple remover 10a away from the surface.

In a case in which the staple is securely engaged with the surface, for example as a result of the staple including extremely long prongs or exhibiting a high degree of mechanical interaction to the surface, lift provided by the wedging action of the points 22a, 24a underneath the staple may be insufficient to allow the removal of the staple by withdrawing the staple remover 10a away from the surface. In such a case, the staple may be grasped by the jaws 12a, 14a, and the staple remover 10a may be rocked back and forth across the arcuate head 40. The rocking motion across the arcuate head 40 of the staple remover 10a may provide additional lifting of the staple away from the surface, which may loosen the staple and/or allow the complete removal of the staple.

Consistent with the embodiment illustrated in FIG. 3, at least one of the jaws 12a may include a fulcrum heel 42. The fulcrum heel 42 may be used to exert a prying force on a staple in a manner similar to the use of a claw hammer or pry bar. For example, once a staple has been gripped by the jaws 12a, 14a, e.g. by at least partially wedging the points 22a, 24a under the staple, the staple remover 10a may be rocked across the fulcrum heel 42. Rocking the staple remover 10a across the fulcrum heel 42 may provide sufficient leverage to further extract the staple from the surface. In addition to increasing the leverage, the fulcrum heel 42 may also provide a longer lever arm, i.e., from the staple to the rear or the fulcrum heel 42. The longer lever arm provided by the fulcrum heel 42 may allow a greater degree of displacement or lift during extraction of a staple. In a case where levering the staple remover 10a across the fulcrum heel 42 does not fully extract a staple, the staple may be further extracted by withdrawing the staple remover 10a away from the surface.

According to one embodiment, the head of the staple remover 10a may be designed to have a relatively narrow width W. The relatively narrow width W may allow a staple to be removed from a surface by engaging a portion of the staple adjacent to one of the prongs of the staple. Accordingly, it may be possible to remove a staple that is securing, for example an electrical cable or wire, and not impact the sensitive cable in a damaging way. To this end, an embodiment consistent with the present disclosure may include jaws 12a, 14a that taper in only one plane. For example, the lateral face 30a may not converge with the medial surface 32a to form a point 22a. According to such an embodiment, the jaw 12a may only come to a point 22a when viewed in profile, as a result of the converging bearing surface 26a and lifting surface 28a.

According to one aspect, it is recognized that the points of the jaws may be sharp. Therefore, according to one embodiment, the staple remover may be provided with jaws having overlapping points that do not extend beyond the adjacent jaw when the staple remover is in a closed configuration. In this manner, the sharp points may be effectively covered by the opposing jaw when the staple remover is in a closed configuration.

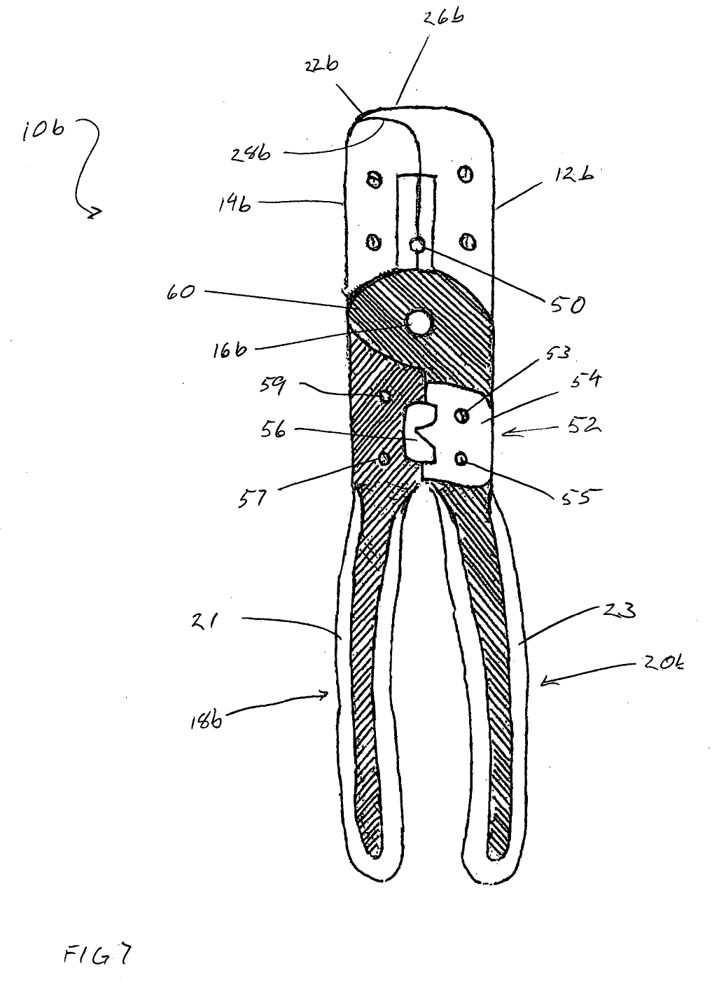

Turning to FIG. 7, another embodiment of a staple remover 10b is shown. The staple remover 10b may include first and second jaws 12b, 14b pivotally engaged with one another about pivot 16b. The jaws 12b and 14b may be coupled across the pivot 16b to first and second handles 18b, 20b. The jaws 12b, 14b may be directly coupled to the handles 18b, 20b as shown in the illustrated embodiment. Alternatively, the jaws 12b, 14b may be indirectly coupled to the handles 18b, 20b through one or more intermediary components. Pivotal movement of the handles 18b, 20b relative to one another may produce a corresponding movement of the jaws 12b, 14b relative to one another.

With reference to the first jaw 12b, as with preceding embodiments, the jaws 12b, 14b may include points, e.g. 22b, formed by converging bearing surface 26b, and lifting surface 28b. The point 22b may also be formed by converging lateral and medial surfaces of the jaw 12b. The second jaw 14b may include a point formed by corresponding converging surfaces. The points may be used to remove a staple in a manner similar to the previously described embodiments.

In addition to the points 22b, 24b for removing staples, the staple remover 10b may include other useful features. For example, in the illustrated embodiment, the staple remover 10b is shown including a wire stripper 50 provided by the jaws 12b and 14b. The wire stripper 50 may include a circular aperture formed between the jaws 12b, 14b that may be sized to strip wire of predetermined thickness, e.g. a 12 gage wire. Similarly the wire stripper 50 may include a plurality of apertures formed between the jaws 12b, 14b capable of stripping wires or different thicknesses.

According to another aspect, the staple remover 10b may include a jacket stripper 52 for removing the outer jacket or sheathing from non-metallic sheathed electrical cable. The jacket stripper 52 may include cooperating features 54, 56 on respective handles 20b, 18b for cutting and removing the sheathing from an electrical cable. The jacket stripper 52 may be employed by opening the jacket stripper 52 by separating the handles 18b, 20b, inserting the sheathed cable, closing the handles 18b, 20b and withdrawing the sheathed cable.

In other contemplated embodiments, the staple remover 10b may include various other features in addition to, or as an alternative to, the wire stripper 50 and/or the jacket stripper 52. For example, the staple remover 10b may include a crimping tool, wire cutters, etc. Additional or alternative features may be incorporated in on either the jaw side of the pivot 16a or on the handle side of the pivot 16a.

According to one aspect, the jaws according to any embodiment may optionally be provided as removable features. For example, in the embodiment of a staple remover 10 illustrated in FIGS. 1 and 2, the jaws 12, 14 are shown including pockets, for example pocket 13 in a side face of the second jaw 14. The handles 18 and 20 may include extensions above the pivot 16, for example 15 extending from the handle 20. The extensions 15 may be received in the pocket 13 of the jaw 14. In the illustrated embodiment, the jaw 14 may be retained to the extension 15 of the handle 20 using screws 17 and 19. Other retention features, such as rivets, etc., may also be used to retain the jaw 14, to the handle 20. A similar construction may be used to retain the other jaw 12 to the other handle 18.

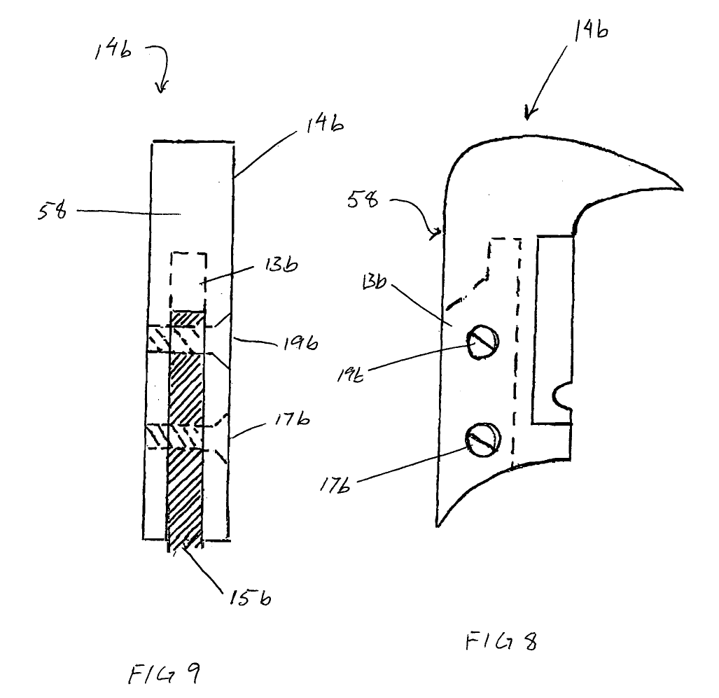

With reference also to FIGS. 8 and 9, an embodiment is shown for providing the jaws 12b, 14b as removable components of the staple remover 10b. For the purpose of describing this embodiment, only the jaw 14b is depicted retained to the handle 20b. The jaw 12b may be retained to the handle 18b in a similar manner. As shown, the handle 20b may include an extension 15b that may extend above the pivot 16b. The jaw 14b may include a pocket 13b or recess extending into the jaw 14b from a side edge 58 of the jaw 14b. The extension 15b of the handle 20b may be at least partially received in the pocket 13b. The extension 15b may be retained in position in the pocket 13b by screws 17b, 19b, or similar retention features. Retention of the jaws 12b, 14b to the handles 18b, 20b may be sufficiently secure to allow force applied to the handles 18b, 20b to the transferred through the jaws 12b, 14b.

Providing the jaws as removable features may allow the jaws to be replaced in the event that they become damaged. Additionally, removable jaws may be exchanged with jaws suited for uses other than the removal of staples. For example, the staple removal jaws may be replaced with jaws configured to provide conventional pliers, needle nose pliers, etc. Accordingly, one set of handles may be used to provide numerous different tools. This may be convenient during demolition or construction projects wherein it may be inconvenient for a worker to carry a full array of tools on his person.

In a similar manner as the jaws, other features of the staple remover 10b may also be removable and/or replaceable. For example, the jacket stripper 52 and or the wire stripper 50 may be provided as removable or replaceable features. Consistent with the illustrated embodiment of FIG. 7, the first feature 54 of the jacket stripper 52 is shown attached to the handle 20b using screws 53, 55 or similar retention features. Similarly, the second feature 56 of the jacket stripper 52 may also be attached to the handle 18b using screws 57, 59, etc. While not shown in detail, the wire stripper 50 may be removably attached to the jaws 12b, 14b in a similar manner as the jacket stripper 52. The wire stripper 50 may, therefore, also be replaced or exchanged for a different feature or tool.

According to one embodiment, the staple remover 10b may be include a main body portion 60, indicated by cross-hatching in FIG. 7, including the handles 18b, 20 and a region around the pivot 16b. The main body portion 60 may be formed separately from the jaws 12b, 14b and auxiliary features such as the wire stripper 50 and jacket stripper 52. The main body portion 60 may also be formed from a different material than the jaws 12b, 14 and/or features such as the wire stripper 50 and jacket stripper 52. In one embodiment, the main body portion may be formed from stamped steel. The handle portions 18b, 20b may include a plastic covers 21, 23. The plastic covers may be, for example, dip coated vinyl, or may be molded and provide an ergonomic grip. Other suitable techniques may also be used to apply a plastic layer over at least a portion of the handles 18b, 20b. In addition to providing a more comfortable grip, the plastic covers 21, 23 may also provide at least some degree of electrical insulation, for example to protect against a breach of a live wire.

The jaws 12b, 14b may be formed using a powdered metal casting process. Powdered metal casting may include compacting a powdered metal into a mold and sintering the shaped powdered metal. Powdered metal casting may be employed to produce complex forms using almost any metal or alloy. In one embodiment, an iron based alloy may be used to produce the jaws 12b, 14b using a powdered metal casting process. According to such an embodiment, it may be possible to provide the jaws 12b, 14b having a hardness in the range of about 45 on the Rockwell C scale.

Various other metal forming techniques may be used to form the jaws 12b, 14b and/or the main body portion. Exemplary techniques may include casting, forging, machining, stamping, etc. Any of the preceding forming techniques may also be used to produce tools, attachments, or features for the staple remover, such as the wire stripper 50 or the jacket stripper 52, etc.

Accordingly, consistent with the present disclosure there may be provided a staple remover including a first jaw pivotally engaged to a second jaw, said first jaw including a converging first lifting surface and first bearing surface, and said second jaw including a converging second lifting surface and second bearing surface. The staple remover may also include a first handle coupled across the pivot to the first jaw and a second handle coupled across the pivot to the second jaw, in which the first and second jaws may be at least partially overlapping in a closed configuration.

Consistent with the present disclosure there may also be provided a staple remover including a first and second handle pivotally engaged about a pivot. The staple remover may also include a first jaw including a converging first bearing surface and first lifting surface, in which the first jaw is removably retained to the first handle, and a second jaw including a converging second bearing surface and second lifting surface, in which the second jaw is removably retained to the second handle, and the first and second jaws are at least partially overlapping in a closed configuration.

The embodiments that have been described herein are but some of the several which are consistent with the claimed subjected matter, and are set forth here by way of illustration, but not of limitation. Many other embodiments, which will be readily apparent to those skilled in the art, may be made without departing materially from the spirit and scope of the claims appended hereto.

What is claimed is:

1. A staple remover comprising:
a first jaw pivotally engaged to a second jaw, said first jaw comprising a converging first lifting surface and first bearing surface, and said second jaw comprising a converging second lifting surface and second bearing surface; and
a first handle coupled across said pivot to said first jaw and a second handle coupled across said pivot to said second jaw;
said first and second jaws at least partially overlapping in a closed configuration.

2. A staple remover according to claim 1 wherein said first jaw comprises a converging first medial surface and first lateral surface, and said second jaw comprises a converging second medial surface and second lateral surface.

3. A staple remover according to claim 1 wherein said first and second lifting surfaces comprise an arcuate surface.

4. A staple remover according to claim 1 wherein said first jaw comprises a fulcrum heel on a side opposite said first point.

5. A staple remover according to claim 1 wherein said first jaw is removable from said staple remover.

6. A staple remover according to claim 5 wherein said first jaw comprises a pocket formed in a medial face of said jaw, and said first handle comprises an extension releasably retainable in said pocket.

7. A staple remover according to claim 5 wherein said first jaw comprises a pocket extending from an edge of said jaw, and said first handle comprises an extension releasably retainable in said pocket.

8. A staple remover according to claim 1 further comprising a wire stripper comprising an aperture defined between said first and second jaw.

9. A staple remover according to claim 8 wherein said wire stripper comprises a first member removably retained to said first jaw and a second member removably retained to said second jaw, said aperture defined between said first and second members.

10. A staple remover comprising:
a first and second handle pivotally engaged about a pivot;
a first jaw comprising a converging first bearing surface and first lifting surface, said first jaw removably retained to said first handle; and
a second jaw comprising a converging second bearing surface and second lifting surface, said second jaw removably retained to said second handle.

11. A staple remover according to claim 10, wherein said first handle comprises a first extension and said first jaw is removably retained to said first extension, and said second handle comprise a second extension and said second jaw is removably retained to said second extension.

12. A staple remover according to claim 11, wherein said first jaw comprises a first pocket and said first extension is at least partially received in said first pocket, and said second jaw comprises a second pocket and said second extension is at least partially received in said second pocket.

13. A staple remover according to claim 12 wherein said first pocket extends inwardly from a medial surface of said first jaw, and said second pocket extends inwardly from a medial surface of said second jaw.

14. A staple remover according to claim 12 wherein said first pocket extends inwardly from a side edge of said first jaw, and said second pocket extends inwardly from a side edge of said second jaw.

15. A staple remover according to claim 10 comprising a first crimper jaw disposed on said first handle and a second crimper jaw disposed on said second handle.

16. A staple remover according to claim 15 wherein said first and second crimper jaws are removably retained to said first and second handle.

17. A staple remover according to claim 10 comprising a first wire stripper feature disposed on said first jaw and a second wire stripper feature disposed on said second jaw, said first and second wire stripper features defining an aperture therebetween.

18. A staple remover according to claim 17 wherein said first wire stripper feature is removable retained to said first jaw and said second wire stripper feature is removably retained to said second jaw.

19. A method of removing a staple comprising:
providing a first jaw comprising a converging first lifting surface and first bearing surface and a converging first medial surface and first lateral surface and a second jaw comprising a converging second lifting surface and second bearing surface and a converging second medial surface and second lateral surface;
disposing said first and second jaws on opposed sides of a staple;
forcing said staple upwardly and outwardly by moving said first and second jaw into an at least partially overlapping arrangement underneath said staple.

20. The method according to claim 19 wherein said first jaw comprises a fulcrum heel, said method further comprising rocking said staple remover across said fulcrum heel.
